(19) United States
(12) Patent Application Publication
(10) Pub. No.: US 2023/0019950 A1
(43) Pub. Date: Jan. 19, 2023

(54) DRIP IRRIGATION PIPE AND AN IRRIGATION SPOUT THEREOF

(71) Applicant: NETAFIM, LTD., TEL AVIV (IL)

(72) Inventors: YUVAL MENAHEM GABAY, BEER SHEVA (IL); ABED MASARWA, TAYBI (IL)

(73) Assignee: NETAFIM, LTD., TEL AVIV (IL)

(21) Appl. No.: 17/952,731

(22) Filed: Sep. 26, 2022

Related U.S. Application Data
(63) Continuation-in-part of application No. PCT/IB2021/052185, filed on Mar. 16, 2021.
(60) Provisional application No. 62/994,325, filed on Mar. 25, 2020.

(51) Int. Cl. A01G 25/02

(52) U.S. Cl. CPC A01G 25/023

(57) ABSTRACT

A spout member for attachment to an outer side of a drip irrigation pip has a lower side arranged to attach the pipe. The lower side of the spout member includes at least one rib for facilitating its attachment, where attachment may be to an irrigation pipe, possibly a drip irrigation pipe.

### RELATED APPLICATIONS

This is a Bypass Continuation-in-Part of International Application No. PCT/IB2021/052185 filed Mar. 16, 2021, which claims priority to U.S. Provisional patent application No. 62/994,325 filed Mar. 25, 2020. The contents of the above-mentioned applications are incorporat3ed by reference in their entirety.

### TECHNICAL FIELD

Embodiments of the invention relate to a drip irrigation pipe and an irrigation spout thereof, and in particular to such irrigation spout being attached to an outer side of a drip irrigation pipe over an outlet aperture in the pipe.

### BACKGROUND

Irrigation water emitted by drip emitters within a drip irrigation pipe may be arranged to communicate the emitted water to lateral tubes. These tubes may then be used to direct the water to plants (or the like).

US2002104903 describes an irrigation apparatus with in-line drippers that have supports for attaching a micro tube to the dripper outlet. The support here has a projection, sleeve or connector for securing a micro tube thereto.

### SUMMARY

The following embodiments and aspects thereof are described and illustrated in conjunction with systems, tools and methods which are meant to be exemplary and illustrative, not limiting in scope.

In at least certain embodiments there is provided a spout member for attachment to an outer side of a drip irrigation pipe, the spout member comprising a lower side arranged to attach the pipe, wherein the lower side comprises at least one rib for facilitating said attachment.

A spout member may be an element that communicates liquid therethrough its passage to additional irrigation elements that may be attached, possibly detachably attached, to its downstream side. In some cases, a spout member may also be integrally fitted with elements that interact with liquid flowing through a passage of the spout member.

In an embodiment there is also provide an irrigation device comprising a drip emitter, a spout member and a pipe comprising a pipe wall that is sandwiched between the drip emitter and spout member, an aperture in the pipe wall providing a route for water emitted by the drip emitter to flow downstream towards an axially extending passage formed through the spout member, wherein in cross sections taken along the axis of the passage an entry section of the passage comprises a larger cross sectional area than a main section of the passage that is immediately downstream to the entry section.

In an embodiment there is also provide a method for attaching a spout member to an outer side of a drip irrigation pipe comprising the steps of: providing a drip irrigation pipe comprising a drip emitter bonded to an inner side of the pipe and an aperture formed through a wall of the pipe above the emitter, providing a spout member comprising a through going passage and at least one rib formed about an entry section of the passage at a side of the spout member that is arranged to attach to the pipe, and attaching the spout member to the pipe wall so that the entry section of the spout member's passage overlies the aperture in the pipe wall.

### BRIEF DESCRIPTION OF THE FIGURES

Exemplary embodiments are illustrated in referenced figures. It is intended that the embodiments and figures disclosed herein are to be considered illustrative, rather than restrictive. The invention, however, both as to organization and method of operation, together with objects, features, and advantages thereof, may best be understood by reference to the following detailed description when read with the accompanying figures, in which:

FIG. 1A schematically shows a drip irrigation pipe and an irrigation spout according to an embodiment of the present invention attached to an outer side of the pipe;

FIG. 1B schematically shows the drip irrigation pipe and spout of FIG. 1A prior to attachment of the spout to the pipe;

FIG. 1C schematically shows a cross sectional view of the drip irrigation pipe and spout of FIG. 1A and an enlarged section of the spout where it attaches to the drip irrigation pipe;

FIGS. 2A and 2B schematically show, respective, top and bottom perspective views of an embodiment of an irrigation spout;

FIGS. 3A and 3B schematically show, respective, top and bottom perspective views of another embodiment of an irrigation spout;

FIGS. 4A and 4B schematically show, respective, top and bottom perspective views of yet another embodiment of an irrigation spout;

FIGS. 5A and 5B schematically show each top views of yet further irrigation spout embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

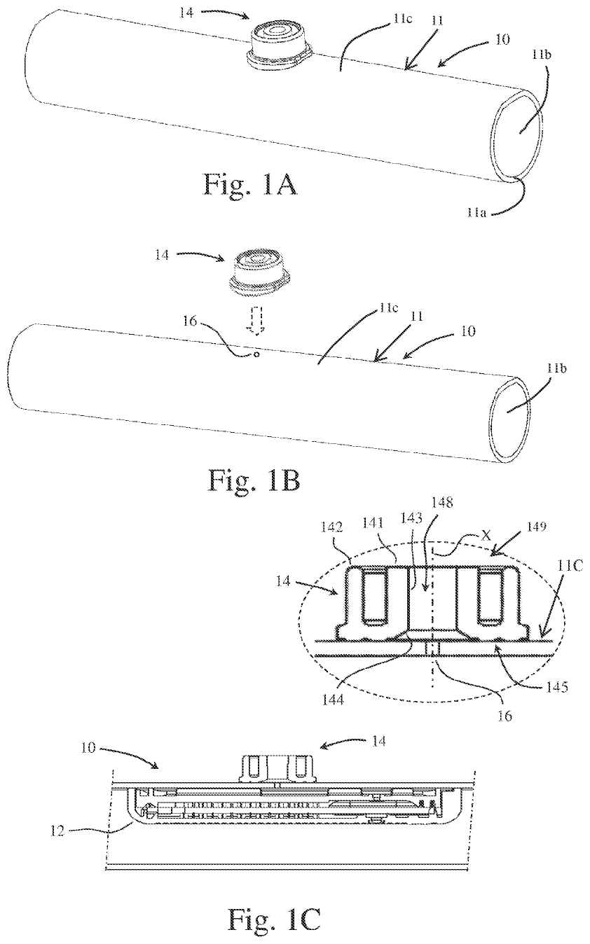

Attention is first drawn to FIGS. 1A to 1C schematically illustrating a drip irrigation pipe 10 including a pipe member 11 having a pipe wall 11a with an inner surface 11b and outer surface 11c. The pipe member 11 houses a drip emitter 12 that is attached (preferably bonded) to its inner side/surface 11b, and an embodiment of an irrigation spout 14 that is attached (preferably bonded) to its outer side/surface 11c. The spout 24 as here seen is attached to the outer surface 11c of the pipe member 11 above an aperture 16 of the pipe member 11 through which water emitted by a drip emitter exists the pipe.

In the embodiments disclosed here, preferably the spout 14 is sealingly attached to the pipe's outer surface so that substantially all water exiting a drip emitter are routed through the spout onwards downstream, without substantially leaking out through the connection between spout and pipe member 11.

Spout 14 as seen in the enlarged section of FIG. 1C may be generally formed about an axis X and may have an upwardly/outwardly projecting axially extending stem 141 and a peripheral wall 142 that may be generally formed about the stem. A tube (not shown) may be coupled to an outer side of the spout e.g. by snuggly fitting upon stem 141 and possibly pressed in between stem 141 and wall 142.

As seen in the figures, the stem 141 has an annular shape while the wall 142 has a cylindrical shape.

Such tube that is attached to spout 14 may be arranged to communicate water exiting the drip irrigation pipe 10 onwards downstream e.g. towards plants. In certain cases, an end of such tube may be coupled to the stem 141 and/or wall 142 via a coupler (also not shown) that is arranged to mate with the stem and/or wall.

Spout 14 has an upper side 149, a lower side 145 and in addition includes a through going passage 148 that extends along axis X generally through the stem 141 while opening out to a lower/inner side 145 of the spout and to an upper/outer side of the spout at the upper/outer side of the stem. Passage 148 may be arranged to include an entry section 144 at its lower/inner side that leads downstream into a main section 143 of the passage. In a direction along the spout axis X, the entry section 144 may be shorter than the main section 143. The entry section 144 has an entry 144a into the passage 148 while the main section 143 has an exit 143a from the passage 148. Entry section 144 may include at least portions that are larger in diameter than the internal diameter of main section 143 of the passage.

The lower/inner side 145 of the spout 14 further comprises a downwardly facing base face 147. In some embodiments, the base face 147 is generally planar. In other embodiments, the base face 147 may follow a generally cylindrical contour. When a generally cylindrical contour is present, the radius of curvature of the cylindrical contour matches that of pipe's outer surface 11c.

In the illustrated views, entry section 144 can be seen having a generally funnel shape converging upwards in a direction away from lower/inner side 145, however entry section 144, when present, may have other forms such as cubic, cylindrical or any other formation possibly larger in cross section (e.g. in diameter in case of cylinder) than main section 143.

It is noted that the directional term outer and lower used with respect to the spout, may be seen defined in relation to the spout when mounted to the drip irrigation pipe-and thus with respect to the radial inner and outer directions of the pipe member 11 when held in a generally cylindrical form.

As schematically seen in FIG. 1B, spout 14 may be attached after or during the manufacturing process of the drip irrigation pipe 10 to the outer side of the pipe member 11. Such attachment of spout 14 to the drip irrigation pipe 10 may preferably be after drip emitters 12 have been attached to the inner side/surface of the pipe member and possibly also after formation of an aperture 16 above each drip emitter.

As seen in the enlarged section of FIG. 1C, a diameter of aperture 16 may typically be smaller than a diameter of main section 143 of the passage 148. In a non-binding example, a diameter of aperture 16 may be about 1.6 millimeters while a diameter of passage 142 may be about 3 millimeters.

In spout embodiments having a wider entry 144a into passage 148, such entry 144a may assist in ensuring that aperture 16 is substantially placed in communication with passage 148 so that water exiting a drip emitter 12 may be provided with a substantial open and free flow path out of the irrigation pipe 10. Such wider entry 144a may in particular assist in suitable placement of the spout 14 over aperture 16 e.g. in cases where the spout is attached to the outer side of the pipe member 11 during manufacturing of the drip irrigation pipe (e.g. when the pipe member 11 is in movement).

In at least certain embodiments, entry section 144 may accordingly be generally funnel shaped with a formation that converges/tapers upwardly towards main section 143 of the passage 148. Such formation may be useful in funneling water exiting an aperture 16 above a drip emitter 12 towards passage 148.

As seen in the enlarged section of FIG. 1C, the spout 14 is attached to the pipe member's outer surface 11c, with no portion of the spout projecting into the pipe member, and no element within the pipe member projecting through the aperture and contacting the spout 14. Thus, the spout may be attached to the pipe member solely by the spout's lower side being heat bonded to the pipe member's outer surface 11c, without adhesive. However, in some embodiments an adhesive may be used.

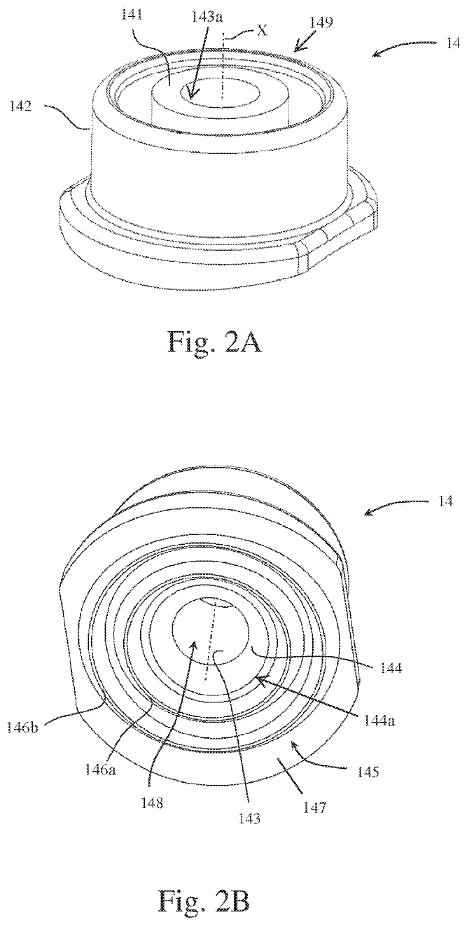

Attention is drawn to FIGS. 2A and 2B illustrating an embodiment of a spout 14. FIG. 2B reveals the lower/inner side 145 of the spout including here two peripheral ribs 146a, 146b formed about axis X. The ribs 146a, 146b project downwards away from the base face 145.

As seen in the figures, two peripheral ribs 146a, 146b may be concentric about the spout axis X and comprise a radially inner first rib 146a and a radially outer second rib 146b.

As also seen in the figures, each peripheral rib may form a closed contour (i.e., one in which the rib is continuous).

While in some embodiments the closed contour may be planar, in other embodiments, the closed contour does not lie in a plane, but rather is three-dimensional.

When the spout is attached (e.g., heat bonded) to the outer surface 11c of the pipe member 11, a water-tight seal may be formed between a peripheral rib having a closed contour and the outer surface 11c.

In the embodiments seen in the figures, the peripheral ribs may form a closed circular contour. In other embodiments, each peripheral rib may form a closed non-circular contour. (e.g., a contour having an oval or other shape).

In some embodiments (not shown), one or more peripheral ribs may be non-continuous with gaps and thus form a broken contour, rather than a closed contour.

In an aspect of the present invention, provision of one or more ribs 146a, 146b upon the lower/inner side 145 of the spout may assist in attachment of the spout to the pipe member's outer surface.

In an embodiment, spout 14 may be attached to the outer side of the pipe member 11 by heat bonding.

Three examples of such heat bonding, each of which comprises the application of heat, and without adhesives, are contemplated.

In one example, heat may be applied to the lower/bottom side of the spout prior to attaching the spout to the pipe member 11, while the one or more ribs 146a, 146b may be seen as deposits of thermoplastic material that can undergo at least partial melting due to exposure to such heat, so that the at least partial melted rib(s) upon contact with the pipe member 11 may assist in heat bonding of the spout to the pipe member 11.

In another example, beads of melted resin may be applied to the lower/inner side 145 of the spout in between adjacent ribs, and substantially immediately thereafter the spout may be pressed against the pipe member's outer surface 11c with the melted resin assisting in heat bonding of the spout to the pipe member 11.

In yet another example, laser energy may be used for assisting in melting of the rib(s) and/or a region of the pipe member 11 where the spout is about to be attached. In such case, spout embodiments may be provided that may be substantially transparent to a laser beam focused at the rib(s) and/or pipe member 11. Such laser energy in a non-binding example may be provided in #wave lengths of about 1060 nanometers (or the like).

In an embodiment, spout 14 may be attached to the outer surface of the pipe member by means not necessarily limited to heat bonding. For example, adhesives may be provided in-between adjacent ribs, prior to attachment of the spout to the pipe member 11. Upon engagement with the pipe member 11, such adhesives may cure and by that securely bond to the spout to the pipe member.

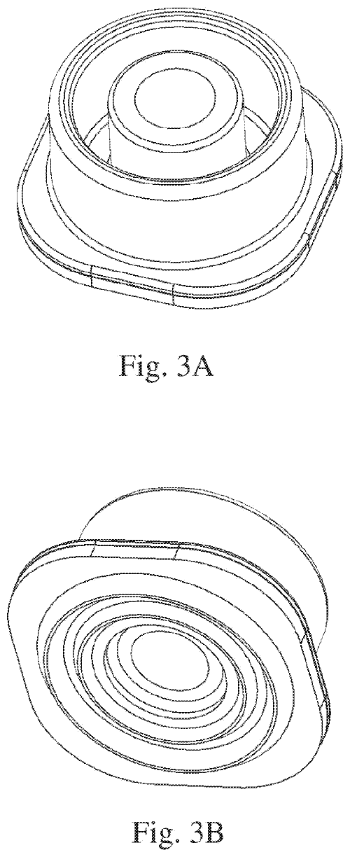

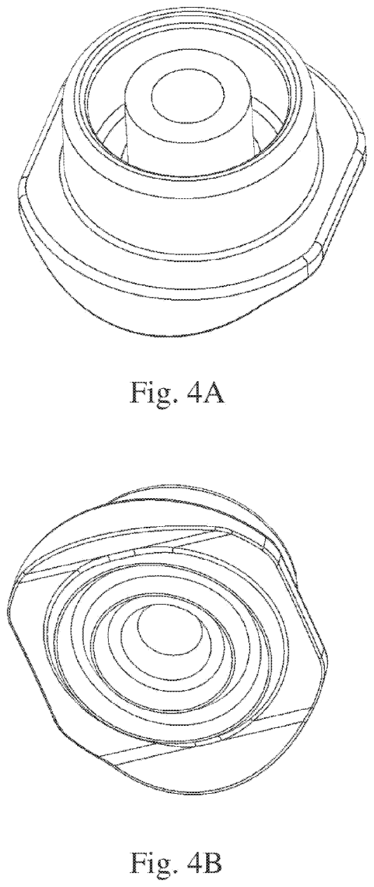

Attention is drawn to FIGS. 3A, 3B, 4A and 4B showing further spout embodiments. The spout of FIGS. 3A and 3B illustrates possible provision of a generally rectangular lower side 145 for a spout. The spout of FIGS. 4A and 4B illustrates possible provision of a spout's lower side 145 that is generally shaped to follow the pipe's cylindrical contour.

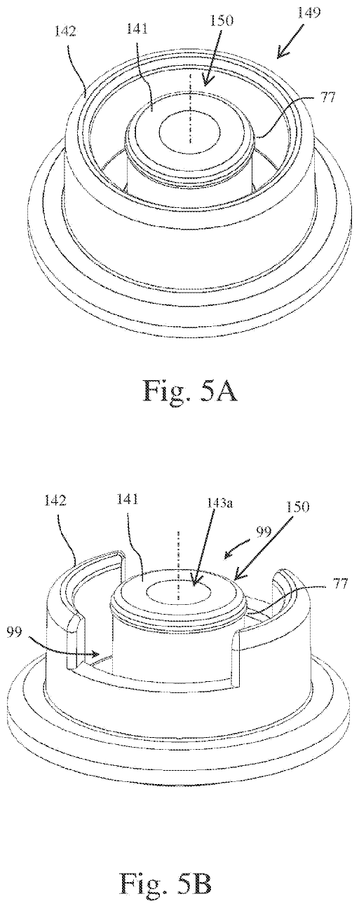

FIGS. 5A and 5B illustrate provision of a possible peripheral rim 77 at an upper side 150 of a spout's stem 141. Rim 77 may be arranged to project laterally away from axis X to assist in gripping of a tube or coupler (not shown) to which the spout may be arranged to attach at its upper/outer side. The spout of FIG. 5B illustrates possible provision of a wall 142 with intermission 99 (“gap”) formed therein. Such intermission(s) 99 may be useful e.g. in easing production of rim 77 during injection molding and/or may provide an opening through wall 142 so that successful attachment of a tube/coupler to the stem may be easily visible.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

Furthermore, while the present application or technology has been illustrated and described in detail in the drawings and foregoing description, such illustration and description are to be considered illustrative or exemplary and non-restrictive; the technology is thus not limited to the disclosed embodiments. Variations to the disclosed embodiments can be understood and effected by those skilled in the art and practicing the claimed technology, from a study of the drawings, the technology, and the appended claims.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage.

The present technology is also understood to encompass the exact terms, features, numerical values or ranges etc., if in here such terms, features, numerical values or ranges etc. are referred to in connection with terms such as “about, ca., substantially, generally, at least” etc. In other words, “about 3” shall also comprise “3” or “substantially perpendicular” shall also comprise “perpendicular”. Any reference signs in the claims should not be considered as limiting the scope.

Although the present embodiments have been described to a certain degree of particularity, it should be understood that various alterations and modifications could be made without departing from the scope of the invention as hereinafter claimed.

What is claimed is:

1. An irrigation spout having a spout axis and comprising:
an upper side;
a lower side;
a through going passage extending along the spout axis, the passage comprising:
an entry section located at the spout's lower side and having an entry into the passage; and
a main section downstream of the entry section, the main section having an exit from the passage which opens out to the upper side;
a downwardly facing base face provided on the lower side; and
at least one rib provided on the lower side, the at least one rib formed at least partially about the entry into the passage, and projecting downwards away from the base face.

2. The irrigation spout of claim 1, wherein the at least one rib comprises a radially inner first rib and a radially outer second rib, each rib comprising a closed contour.

3. The irrigation spout of claim 2, wherein the radially inner first rib and radially outer second rib are concentric about the spout axis, each rib forming a closed circular contour.

4. The irrigation spout of claim 1, wherein the downwardly facing base face is planar.

5. The irrigation spout of claim 1, wherein the downwardly facing base face follows a cylindrical contour.

6. The irrigation spout of claim 1, wherein in cross sections taken along the spout axis, the entry section comprises larger cross sectional areas than the main section immediately downstream to the entry section.

7. The irrigation spout of claim 6, wherein:
the entry section converges in downstream direction, from the entry into the passage to the main section immediately downstream to the entry section.

8. The irrigation spout of claim 1, wherein:
the spout further comprise an upwardly projecting annular stem; and
the exit of the passage is at an upper side of the stem.

9. The irrigation spout of claim 8, wherein the spout further comprises an upwardly projecting wall that is formed at least partially about the stem.

10. The irrigation spout of claim 9, wherein the spout further comprises a peripheral rim located at the upper side of the stem, the peripheral rim projecting laterally away from the stem.

11. The irrigation spout of claim 1, wherein the at least one rib comprises a deposit of thermoplastic material for assisting in heat bonding the spout to a pipe wall, upon undergoing at least partial melting at the rib prior to the attachment.

12. An irrigation pipe comprising:
a pipe member comprising a pipe wall having an inner surface and an outer surface;
an aperture formed through the pipe wall and connecting the inner and outer surfaces;
a drip emitter attached to the inner surface of the pipe wall; and
an irrigation spout in accordance with claim 25 attached to the pipe member; wherein:
the spout's lower side is heat bonded to the pipe member's outer surface; and
the drip emitter and spout are positioned such that water exiting the emitter passes through the aperture and enters the passage.

13. The irrigation pipe of claim 12, wherein:
the spout is attached to the pipe member with no portion of the spout projecting into the pipe member, and no element within the pipe member projecting through the aperture and contacting the spout.

14. The irrigation pipe of claim 13, wherein:
the spout is attached to pipe member solely by the spout's at least one rib being heat bonded to the pipe member's outer surface, and without adhesive.

15. An irrigation pipe comprising:
a pipe member comprising a pipe wall having an inner surface and an outer surface;
an aperture formed through the pipe wall and connecting the inner and outer surfaces; and
a spout having a spout axis, an upper side, a lower side and a through going passage extending along the spout axis;
wherein:
the spout is attached to the pipe member solely by the spout's lower side being heat bonded to the pipe member's outer surface, and without adhesive;
no portion of the spout projects into the pipe member; and
no element within the pipe member projects through the aperture and contacts the spout.

16. The irrigation pipe of claim 15, wherein the spout further comprises:
a through going passage extending along the spout axis, the passage having an entry section located at the spout's lower side and a main section downstream of the entry section which opens out to the upper side, the entry section having an entry into the passage and the main section having an exit from the passage; and
at least one rib provided on the lower side, the at least one rib being formed at least partially about the entry into the passage;
wherein:
the spout's at least one rib is heat bonded to the outer surface of the pipe wall.

17. The irrigation pipe of claim 16, wherein:
the lower side of the spout further comprises a downwardly facing base face; and
the downwardly facing base face follows a cylindrical contour.

18. The irrigation pipe of claim 16 wherein:
the entry into the passage has a larger cross-sectional area than the aperture;
the entry section converges in downstream direction, from the entry into the passage to the main section immediately downstream to the entry section; and
in cross sections taken along the spout axis, the entry section comprises larger cross sectional areas than the main section immediately downstream to the entry section.

19. The irrigation pipe of claim 16, wherein:
the spout further comprise an upwardly projecting annular stem; and
the exit of the passage is at an upper side of the stem.

20. The irrigation pipe of claim 19, wherein the spout further comprises an upwardly projecting wall that is formed at least partially about the stem.

21. The irrigation pipe of claim 20, wherein the spout further comprises a peripheral rim located at the upper side of the stem, the peripheral rim projecting laterally away from the stem.

22. The irrigation spout of claim 16, wherein the at least one rib comprises a radially inner first rib and a radially outer second rib, each rib comprising a closed contour.

23. The irrigation spout of claim 22, wherein the radially inner first rib and radially outer second rib are concentric about the spout axis, each rib forming a closed circular contour.

24. The irrigation pipe of claim 16, wherein the at least one rib comprises a deposit of thermoplastic material, for assisting in heat bonding of the spout to the pipe wall by undergoing at least partial melting at the rib prior to the attachment.

25. An irrigation pipe comprising:
a pipe member comprising a pipe wall having an inner surface and an outer surface;
an aperture formed through the pipe wall and connecting the inner and outer surfaces;
a drip emitter attached to the inner surface of the pipe wall; and
a spout having a spout axis, an upper side, a lower side and a through going passage extending along the spout axis, the passage having an entry section located at the spout's lower side and a main section downstream of the entry section which opens out to the upper side, the entry section having an entry into the passage and the main section having an exit from the passage, the spout further comprising at least one rib provided on the lower side and formed at least partially about the entry into the passage; wherein:
the spout's at least one rib is heat bonded to the outer surface of the pipe wall; and
the drip emitter and spout are positioned such that water exiting the emitter passes through the aperture and enters the through going passage.

26. The irrigation pipe of claim 25, wherein the at least one rib comprises a radially inner first rib and a radially outer second rib, each rib comprising a closed contour.

27. The irrigation pipe of claim 26, wherein the radially inner first rib and radially outer second rib are concentric about the spout axis, each rib forming a closed circular contour.

28. The irrigation pipe of claim 25, wherein:
the lower side of the spout further comprises a downwardly facing base face; and
the downwardly facing base face follows a cylindrical contour.

29. The irrigation pipe of claim 25, wherein:
the entry into the passage has a larger cross-sectional area than the aperture;
the entry section converges in downstream direction, from the entry into the passage to the main section immediately downstream to the entry section; and
in cross sections taken along the spout axis, the entry section comprises larger cross sectional areas than the main section immediately downstream to the entry section.

30. The irrigation pipe of claim 25, wherein:
the spout further comprise an upwardly projecting annular stem;
the spout further comprises an upwardly projecting wall that is formed at least partially about the stem; and
the exit of the passage is at an upper side of the stem.

31. The irrigation pipe of claim 30, wherein the spout further comprises a peripheral rim located at the upper side of the stem, the peripheral rim projecting laterally away from the stem.

32. The irrigation pipe of claim 25, wherein both the drip emitter and spout are heat bonded to the pipe wall.

33. The irrigation pipe of claim 25, wherein the at least one rib comprises a deposit of thermoplastic material, for assisting in heat bonding of the spout to the pipe wall by undergoing at least partial melting at the rib prior to the attachment.

34. The irrigation pipe of claim 25, wherein:
the spout is attached to the pipe member with no portion of the spout projecting into the pipe member, and no element within the pipe member projecting through the aperture and contacting the spout.

35. The irrigation pipe of claim 34, wherein:
the spout is attached to pipe member solely by the spout's lower side being heat bonded to the pipe member's outer surface, and without adhesive.

36. A method for attaching a spout to an outer side of a drip irrigation pipe comprising:
providing a drip irrigation pipe comprising a drip emitter bonded to an inner surface of the pipe and an aperture formed through a wall of the pipe above the drip emitter,
providing a spout a having a spout axis, an upper side, a lower side, a through going passage extending along the spout axis and at least one rib formed about an entry of the passage proximate the lower side; and
attaching the spout member to the pipe wall so that the entry section of the spout member's passage overlies the aperture in the pipe wall.

37. The method of claim 36, further comprising at least partially melting the at least one rib prior to attachment of the spout to the pipe wall.

38. The method of claim 37, comprising applying heat to the at least one rib.

39. The method of claim 37, comprising focusing laser energy at the at least one rib.

40. The method of claim 36, wherein:
the at least one rib comprises a radially inner first rib and a radially outer second rib, each rib comprising a closed contour; and the method further comprises:
applying beads of melted resin in between the first and second ribs prior to attachment of the spout member to the pipe wall.

41. The method of claim 36, wherein:
the at least one rib comprises a radially inner first rib and a radially outer second rib, each rib comprising a closed contour; and the method further comprises:
applying adhesive in between the first and second ribs prior to attachment of the spout member to the pipe wall.
